(19) United States
(12) Patent Application Publication
(10) Pub. No.: US 2016/0276874 A1
(43) Pub. Date: Sep. 22, 2016

(54) Power Generation Via Proximity Sensor And Wireless Internet

(71) Applicant: Vyner Vivian Raya, Kuching Sarawak (MY)

(72) Inventor: Vyner Vivian Raya, Kuching Sarawak (MY)

(21) Appl. No.: 15/168,058

(22) Filed: May 29, 2016

(30) Foreign Application Priority Data
Apr. 5, 2016 (MY) 15/091,548

(51) Int. Cl. H02J 50/60

(52) U.S. Cl. CPC H02J 50/60

(57) ABSTRACT

Advantage should be taken for all the efforts by the major tech superpowers in supplying internet to the most secluded places on earth, and the current trend that almost everyone has a smartphone—to produce a collective and almost effortless way of harnessing energy and supplying electricity to all. This can be achieved by utilising the technology of proximity sensor by monitoring movement and close-proximity detection as energy provider. The detection will trigger sending up of signals and activation for receiver which is translated into vibration to power up generator. The transfer of the energy from the proximity sensor to the vibration generator will be completed and done with internet as the medium. With every proximity changes, vibration will be induced via internet connectivity and will be picked up by the generator to produce electricity. This is a simple utilisation of internet to produce electrical energy through sensors.

### TECHNICAL FIELD

The present invention relates to detection nearness/closeness of object to the proximity sensor for use in communication with vibration generator via internet connection for electricity production.

### BACKGROUND OF THE INVENTION

In the age of internet of things and worldwide coverage of wireless connectivity, the full potential of the technology has not been fully explored and utilised yet. Even at the current age of advanced technology available across the world, power generation and supply to every places on earth is still one of the major problems that is yet to be solved. The problem is made worse when in order to have power, the input tools sometimes have to be huge machines that requires huge area and huge allocation for the purpose of harnessing huge energy input. Electricity provision machine is another huge machine that would be needed to cater the energy input and converting the supplied energy into electricity as output to be supplied to the whole community or nation.

Energy input is another big problem, nowadays in order for power generation to be done, it requires too much energy to power up places and locations. Human has to do a great deal of work—directly or indirectly—in order for electrical energy to be produced. A solution needs to be provided that requires very minimal energy but somehow can produce large electrical output for consumers.

Another problem is that we have not explored the usage of internet to its full potential. Internet is massively being used around the world and almost everyone—even in the third world and developing countries—it is better to make use of that situation and get it being used to harness energy.

There are also a lot of internet users around the world—non stop usage in fact—this is some kind of energy and it has a lot of potential and it would be great if that energy can be used for power generation around the world and especially for locations that is still depriving of it.

### BRIEF SUMMARY OF THE INVENTION

The invention is made up of three main things—proximity sensor, satellite internet and vibration generator.

The proximity sensor will sense any close presence of a person or an object—which is a kind of energy. The detected close movement will then be translated into another form of energy which is vibration.

The vibration generator will be receiving a signal to start vibrating whenever there is a detection and sending of the signal by the proximity sensor via the internet. A simple receiver should be installed onto the generator to be able to receive the close proximity detection signals.

The internet will be the medium of transfer of signal between the proximity sensor to the vibration motor. The bigger the coverage of the internet (e.g. satellite signal in space), the more amount of vibration generators can produce electricity after being triggered by the proximity sensor within the area of coverage.

### DRAWING

Refer drawing sheet

### BRIEF DESCRIPTION OF THE DRAWING

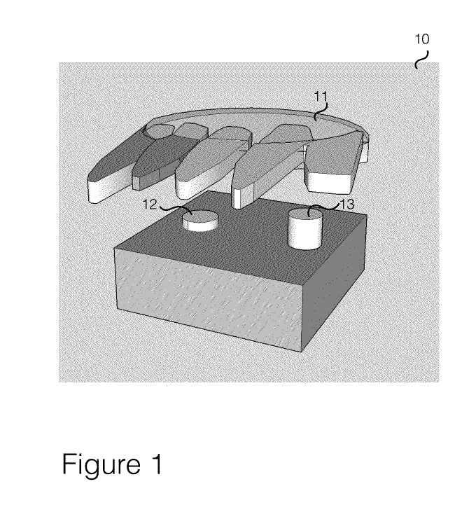

FIG. 1 is a schematic presentation of an object (hand) being brought close to a proximity sensor together with a transmitter in one device.

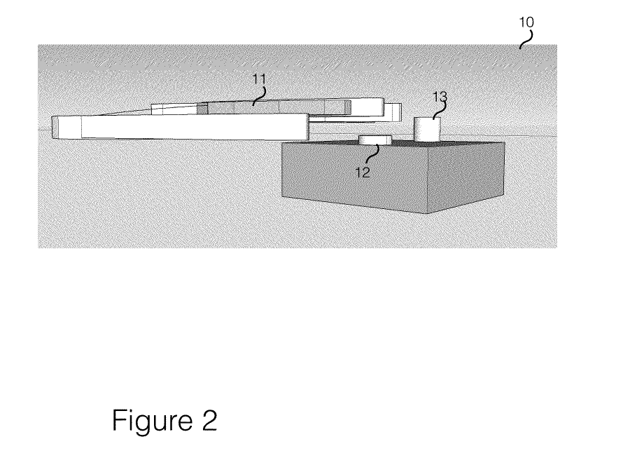

FIG. 2 is another point of view of the object in close position to a proximity sensor.

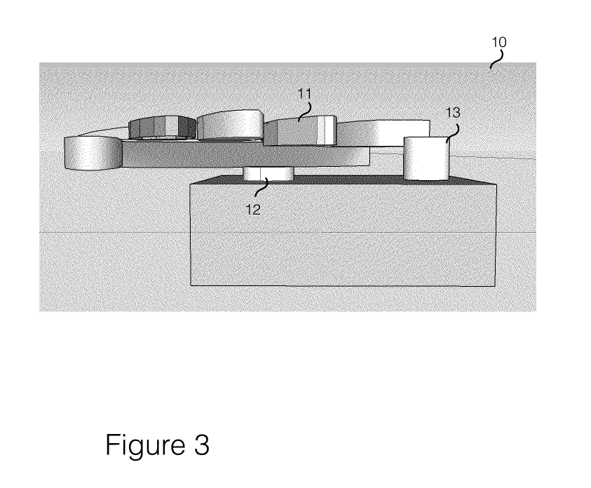

FIG. 3 is the front view of how an object is in close position to a proximity sensor that has transmitter embedded nearby.

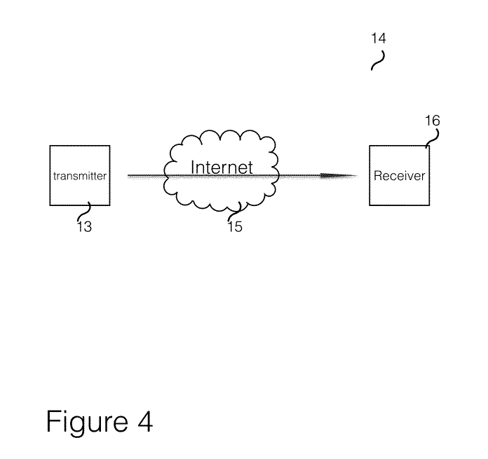

FIG. 4 is a presentation of how the transmitter and receiver communicate the info via the internet network.

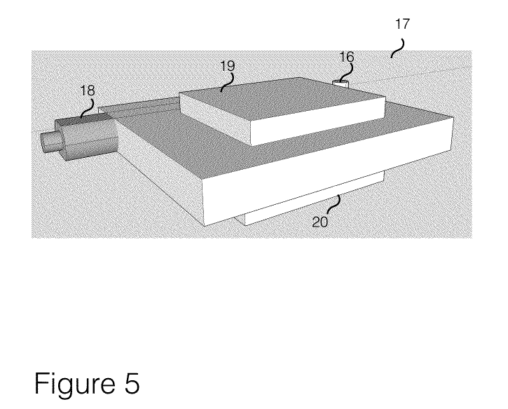

FIG. 5 is a schematic presentation of the vibration generator with motor and receiver embedded together in one device.

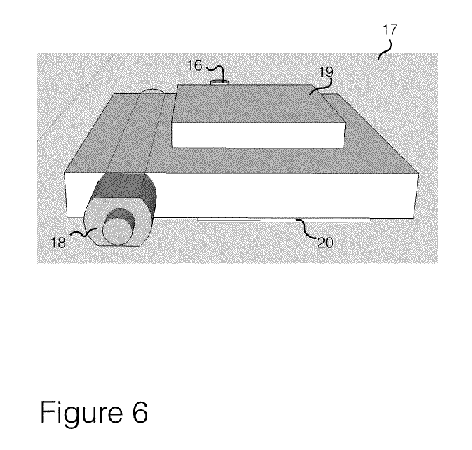

FIG. 6 is another point of view of the vibration generator with motor and transmitter to be the parts of the generator

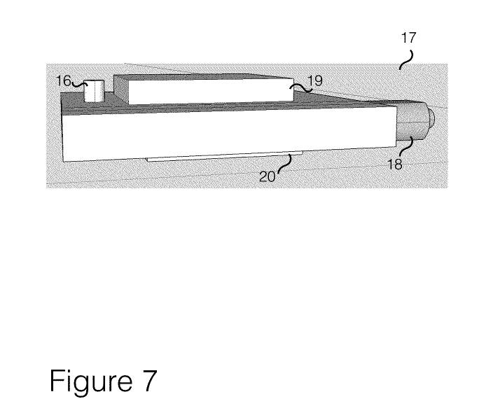

FIG. 7 is the side view of the vibration generator that has motor and transmitter in it.

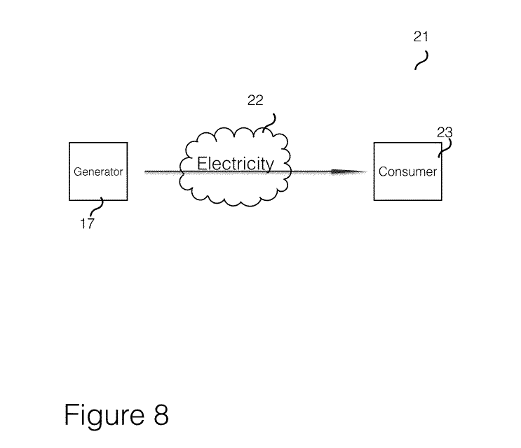

FIG. 8 is a representation of how the electricity generated by vibration generator will reach to consumer.

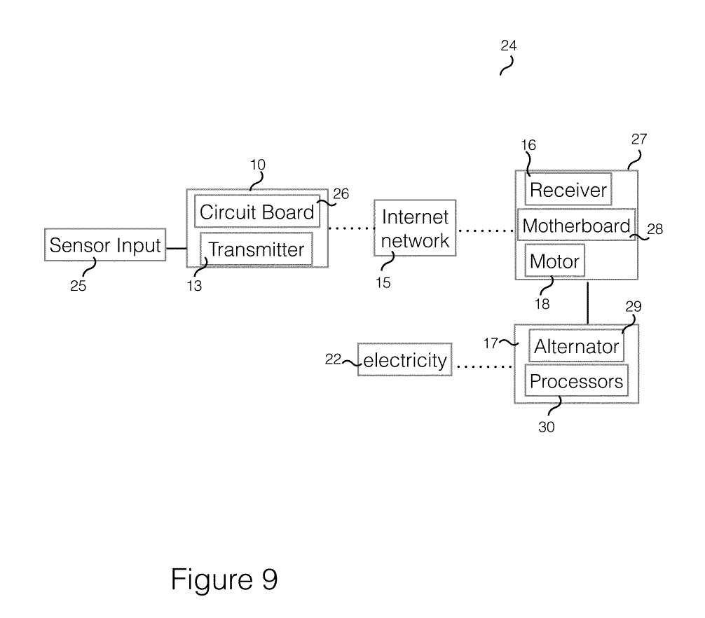

FIG. 9 is a representation of how proximity sensor input is being processed to be transmitted and received through internet network and produces electricity via triggered motor and alternator before going to consumers.

### DETAILED DESCRIPTION OF THE INVENTION

The invention is being made possible by utilisation of portable device 10 that usually have proximity sensor 12 embedded in it. The output of the invention would be the vibration of the motor 18 of the same or another portable device 17. The transmission and receiving of the instruction (coding) are made possible via internet connection 14, between the sensor 12 and the motor 18. A vibration micro-generator 19, 20 is recommended to be installed/coupled with the motor 18 to generate electricity to be used by consumer 23.

The coding can be done with open source language such as Swift (Xcode 7). The first step is by activating the proximity sensor 12 via user interface. Any changes or input 25 detected by the proximity sensor will be processed by the circuit board 26 and vibration system 27 will be activated after being processed by the motherboard 28. The Proximity sensor 12 will then be enabled to monitor and observer ability to observe the subsequent changes in proximity. When the user has triggered another changes 25 in the proximity sensor, the same step will be repeated and the vibration system 27 will be activated again. If the device is being used by itself, there is no need of internet connection.

However, the aim of this invention is to enable vibration of another device that is coupled with a generator 24, hence internet connection 15 needs to be established between the transmitter 13 and the receiver 16. This is being made possible via multiplier connectivity—both transmitter device 13 and receiver device 16 are connecting to the same internet connection. This is established by having the transmitting device to advertise its device to be detected by receiver devices. The receiver device will browse any advertising device in order for connection to be made possible. When the receiver device found the advertising transmitter device, invitation for connection will be done. When the two devices joined each other, the session for both of them will be started. In the session, the transmitter device will be utilised of its proximity sensor in order for the receiver device to receive the data and activate its vibration.

Every smartphones should be equipped with a proximity sensor 12—whenever there is a movement close to the sensor 11, the sensor will detect it. The detection will be used to instruct vibration of motor 18. App with written coding can be prepared for smartphones to trigger proximity sensing when a person put his/her hand near the sensor, or putting the phone in the pocket or have the phone laying face down on the table. Apart from smartphones, independent proximity sensors can be installed on the ground of a lane or walls to detect close proximity of the passing-by lane users.

At current days, most of the devices in the world are able to be connected to the internet and also are able to transmit and receive the data. This is just how the connection and communication between the proximity sensing device and the vibrating device/machine are being done. Through the internet connection, the instruction to trigger the vibration can be cascaded from the proximity sensor.

The communication interface can be done by digital modulation performed by its circuit board 26, with the devices able to access and transport data via the internet networks 15. The network interface should be in a form of wireless interface such as Wi-Fi, Wi-Max, or LTE. The internet connection 15 should be of cloud base network that enable data transfer from a device to another connected devices/machines. The network of internet 15 will be the bridge that links the detection and transmission of the proximity sensing, and with the receiving and triggering of vibration of a motor on another device/machine.

The motor-coupled generator 17 needs to be customised to have processors 30 and magnetic circuit with permanent magnet and coil, called the alternator 29—to be able to detect vibration of the motor 18 for electricity production 22. The generator and alternator basically have magnet coils that create magnetic fields. If there is a disruption of the magnetic fields, because of the movement of a metallic object triggered by vibration of the motor, electricity is produced. Eventually the electricity will be supplied to the consumer 23.

In a nutshell this is utilising internet 15 to produce electricity 22, and application of Internet-of-Things (IoT) to provide power to the consumer. It's like the devices and machines ‘talk’ to each other to produce electricity with a little help from the internet networks and human utilisation of the devices. In another perspective, the first device is just acting like a remote control to get the second device/machine to vibrate and producing electricity, which is completed via internet. At the end of the day, the biggest purpose of this invention is to be able to get generator to produced electricity to the consumer 21.

### Best Mode of Carrying Out The Invention

Satellite will enable worldwide internet coverage and enable any devices in the world to be connected with the generator. A portable internet provider such as flying router would be the good mitigation to close any gap on ultra secluded places that may not be covered by the satellite internet.

Smartphones universally have proximity sensor that is already built-in to detect changes in proximity. The sensor will also enable proximity monitoring, once triggered, to continue observing and detecting further proximity changes.

When there is a detection, the sensors will create a signal to notify another device to react. In this case the reactive device would be the third party vibration generator.

The signal that is created by the sensor will be sent to the third party vibration generator via internet which is made possible through multipeer-connectivity when both devices are under the same wireless internet connection. When different internet wireless connection is being used among them, remote push notification is the wayforward. The preferable way would be multipeer-connectivity to ensure faster and high-reliability response.

### INDUSTRIAL APPLICABILITY

Self smartphone charging: Using proximity sensor to induce vibration which is then captured by micro generator to charge the smartphone.

Home power generation: Using portable proximity sensor to detect close proximity to vibrate the generator for electricity, which is then being transferred to switchboards at home.

Peer smartphone charging: Charging of phone via vibration, but the sending of the signal and proximity sensing is been done by another peer phone.

Peer home power generation: Proximity sensing and power production are done by a peer, and the electricity are shared to other home.

Patent Citation

| | | Publication | | |
|---|---|---|---|---|
| | Filing Date | Date | Applicant | Title |
| U.S. Pat. No. 7,653,883 B2 | Sep. 30, 2005 | Jan. 26, 2010 | Apple Inc. | Proximity Detector in Handheld |
| | | | | Device |
| US 20150138333 | Feb. 28, 2012 | May 21, 2015 | Richard | Agent Interfaces for Interactive |
| | | | Wayne | Electronics that Support Social Cues |
| | | | DeVaul, | |
| | | | Daniel | |
| | | | Aminzade | |
| U.S. Pat. No. 6,281,785 | Mar. 19, 1998 | Aug. 28, 2001 | Sanyo | Vibration Generator for Notification |
| | | | Electric | and Portable Communication device |
| | | | Co., Ltd. | using the vibration generator |
| WO2015092074A1 | Dec. 22, 2014 | Jun. 25, 015 | Avanti | Internet access via satellite |
| | | | Broadband | |
| | | | Limited | |
| WO2014182692 | May 6, 2014 | Nov. 13, 2014 | Convida | Internet of things (iot) adaptation |
| | | | Wireless | services |
| | | | LLC | |

Patent Reference

| | | Publication | | |
|---|---|---|---|---|
| | Filing Date | Date | Applicant | Title |
| US 20160065653 | Aug. 26, 2014 | Mar. 3, 2016 | Fujitsu | Internet of Things (IOT) Device |
| | | | Limited | Configuration Construction |
| US 20160066309 | Aug. 28, 2015 | Mar. 3, 2016 | Samsung | Method and Apparatus for transmitting |
| A1 | | | Electronic | and receiving data |
| | | | Co., Ltd. | |
| US 511916 | Aug. 19, 1893 | Jan. 2, 1894 | Nikola | Electric Generator |
| | | | Tesla | |
| U.S. Pat. No. 2,534,276 A | Apr. 29, 1953 | Sep. 25, 1956 | Jr Joseph H | Vibration Pick-up Device and system |
| | | | Lancor | |
| US 878890 B2 | Mar. 22, 2013 | Jul. 22, 2014 | Leigh M. | System and method for creating a |
| | | | Rothschild | personalised consumer product |

What is claimed is:

1. Proximity Sensor that is easily fixed or readily assembled in a portable device such as smartphones to detect changes in proximity can be used as a trigger or switch to start a work.

2. Wireless internet is a type of energy that can travel and be received to produce electricity.

3. Power generation through energy harnessing can be done by combining claims 1 and 2 with a vibration generator.
